(19) United States
(12) Patent Application Publication
(10) Pub. No.: US 2014/0166127 A1
(43) Pub. Date: Jun. 19, 2014

(54) AUXILIARY INTAKE VALVE DEVICE AND INTAKE SYSTEM EQUIPPED WITH THE SAME

(71) Applicant: Hyundai Motor Company, Seoul (KR)

(72) Inventor: Tae Min Yun, Anyang (KR)

(73) Assignee: HYUNDAI MOTOR COMPANY, Seoul (KR)

(21) Appl. No.: 14/091,672

(22) Filed: Nov. 27, 2013

(30) Foreign Application Priority Data
Dec. 17, 2012 (KR) 10-2012-0147758

(51) Int. Cl. B60K 13/02

(52) U.S. Cl. CPC B60K 13/02
USPC 137/343

(57) ABSTRACT

An auxiliary intake valve device is provided that includes a valve housing that is disposed at an air cleaner cover, has an inlet port and an outlet port, and has a plurality of inlet apertures at the inlet port. In addition, a fixing bracket is disposed within the valve housing and an elastic member is disposed on the fixing bracket. A plurality of valves are supported by the elastic member and are configured to selectively close the inlet apertures and open the inlet apertures when negative pressure is generated at the outlet port.

### CROSS-REFERENCE TO RELATED APPLICATION

This application claims priority to and the benefit of Korean Patent Application No.

10-2012-0147758 filed in the Korean Intellectual Property Office on Dec. 17, 2012, the entire contents of which are incorporated herein by reference.

### BACKGROUND

(a) Field of the Invention

The present invention relates to an auxiliary intake valve device and an intake system equipped with the auxiliary intake valve device. More particularly, the present invention relates to an auxiliary intake valve device that enables a vehicle to be driven when an intake filter is clogged with foreign substances, and an intake system equipped with the auxiliary intake valve device.

(b) Description of the Related Art

Generally, the air utilized by an engine flows through an air cleaner via an intake duct to remove foreign substances and then this filtered air flows into the engine via an intake hose. However, foreign substances such as snow or ice may block the intake filter. As a result, when the intake filter is clogged, the engine may stop or the acceleration performance of a vehicle may deteriorate due to air deficit.

The above information disclosed in this section is only for enhancement of understanding of the background of the invention and therefore it may contain information that does not form the prior art that is already known in this country to a person of ordinary skill in the art.

### SUMMARY

The present invention provides an auxiliary intake valve device having advantages of enabling a vehicle to he driven when an intake valve device is clogged with foreign substances, and an intake system equipped with the auxiliary intake valve device.

An exemplary embodiment of the present invention provides an auxiliary intake valve device that may include a valve housing disposed at an air cleaner cover, having an inlet port and an outlet port, and having one or more inlet apertures at the inlet port; a fixing bracket within the valve housing; an elastic member disposed on the fixing bracket; and one or more valves supported by the elastic member, selectively closing the inlet apertures, and opening the inlet apertures when negative pressure is generated at the outlet port.

A plurality of valves may be provided, the auxiliary intake valve may include a valve disc, the valves may be disposed on the valve disc, and the elastic member may support the valve disc. The bracket may have a plurality of support members fitted in the inlet port. In addition, the inlet apertures may have across-section widening in the air movement direction and the valves may have a trapezoidal cross-section that corresponds to the shape of the inlet apertures. The valve may be made of an elastic material. A filter preventing inflow of foreign substances may he disposed at the outlet port and a fixing protrusion may be formed around the valve housing. An O-ring for air-tightness may he fitted around the valve housing and the valve housing may be formed in a cylindrical shape.

Another exemplary embodiment of the present invention provides an intake system, which may include: an air cleaner that includes an air cleaner body with an air cleaner inlet, an intake filter in the air cleaner body, and an air cleaner cover combined with the air cleaner body and having an air cleaner outlet; and an auxiliary intake valve device that includes a valve housing disposed at the air cleaner cover, having an inlet port and an outlet port, and having one or more inlet apertures at the inlet port, a fixing bracket within the valve housing, an elastic member on the fixing bracket, and one or more valves supported by the elastic member, selectively closing the inlet apertures, and opening the inlet apertures when negative pressure is generated at the outlet port.

A plurality of valves may be provided, the auxiliary intake valve may include a valve disc, the valves may be disposed on the valve disc, and the elastic member may support the valve disc. The bracket may have a plurality of support members fitted in the inlet port. In addition, the intake apertures may have a cross-section widening in the air movement direction and the valves may have a trapezoidal cross-section that corresponds to the shape of the inlet hole. The valve may be made of an elastic material. A filter preventing inflow of foreign substances may be disposed at the outlet port and a fixing protrusion for fixing the auxiliary intake valve device to the air cleaner cover may be formed around the valve housing. An O-ring tor air-tightness between the auxiliary intake valve device and the air cleaner cover may be fitted around the valve housing. The valve housing may be formed in a cylindrical shape.

According to an auxiliary intake valve device of an exemplary embodiment of the present invention and an intake system equipped with the auxiliary intake valve device, a vehicle may travel, when an intake filter is clogged with foreign substances.

### BRIEF DESCRIPTION OF THE DRAWINGS

FIG. 1 is an exemplary view showing an intake system equipped with an auxiliary intake valve device according to an exemplary embodiment of the present invention;

FIGS. 2 and 4 are exemplary projected views showing an auxiliary intake valve device according to an exemplary embodiment of the present invention; and

FIGS. 3 and 5 are exemplary cross-sectional views taken along line A-A in FIG. 1 according to an exemplary embodiment of the present invention.

Description of symbols

| | |
|---|---|
| 10: Auxiliary intake valve device | 20: Valve housing |
| 22: Inlet port | 24: Outlet port |
| 26: Inlet aperture | 30: Fixing bracket |
| 32: Supporting member | 40: Elastic member |
| 50: Valve | 60: Valve disc |
| 70: Filter | 80: Fixing protrusion |
| 90: O-ring | 100: Engine |
| 110: Air cleaner | 120: Air cleaner bodoy |
| 122: Air cleaner inlet | 130: Intake filter |
| 140: Air cleaner cover | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise, it will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, only exemplary embodiments of the present invention have been shown and described, simply by way of illustration. As those skilled in the art would realize, the described embodiments may be modified in various ways, all without departing from the spirit or scope of the present invention. Like reference numerals are given to like components throughout the specification. In the drawings, the thickness of layers, films, panels, regions, etc., are exaggerated for clarity.

The case in which it is represented that each part such as a layer, a film, an area, a plate, or the like, is “on” another part is intended to include not only the case in which each part is “directly on”, but also the case in which the other part is between each part and another part. In contrast, when an element is referred to as being “directly on” another element, there are no intervening elements present.

Throughout the specification, unless explicitly described to the contrary, the word “comprise” and variations such as “comprises” or “comprising,” will be understood to imply the inclusion of stated elements but not the exclusion of any other elements.

An exemplary embodiment of the present invention will hereinafter be described in detail with reference to the accompanying drawings.

An intake system equipped with an auxiliary intake valve device according to an exemplary embodiment of the present invention may include an air cleaner 110 that has an air cleaner body 120 with an air cleaner inlet 122 on an engine 100, an intake filter 130 in the air cleaner body 120, and an air cleaner cover 140 combined with the air cleaner body 120 and having an air cleaner outlet 142; and an auxiliary intake valve device 10.

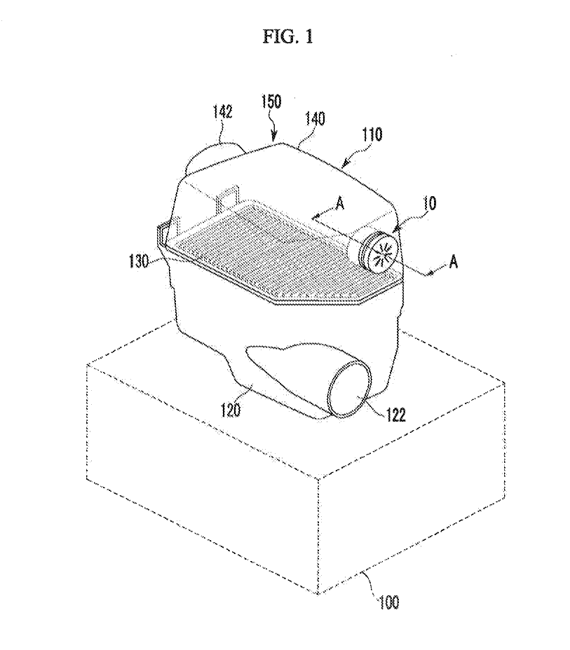

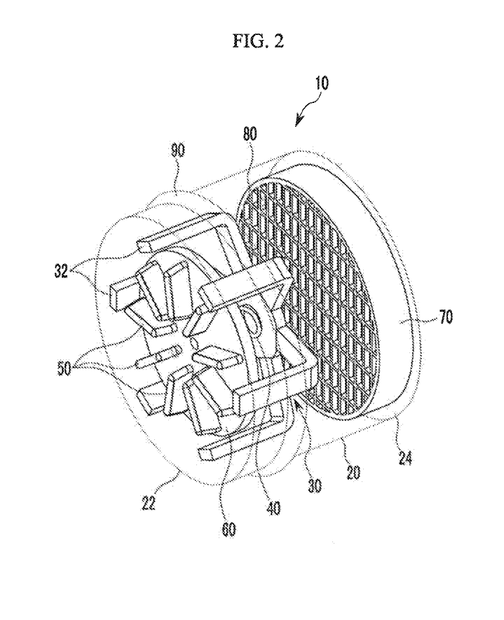

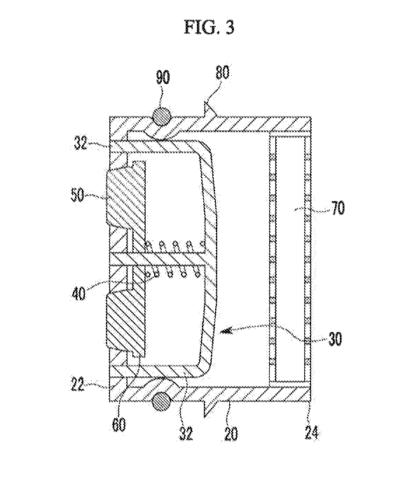

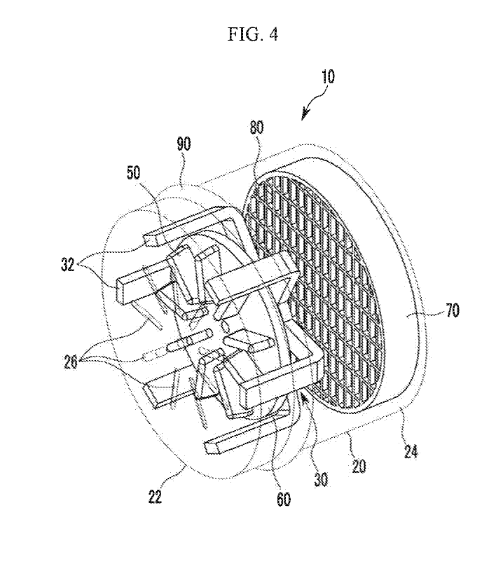

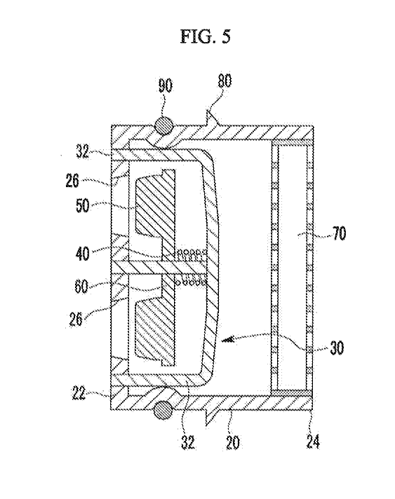

FIGS. 2 and 4 are exemplary projected views showing an auxiliary intake valve device according to an exemplary embodiment of the present invention and FIGS. 3 and 5 are exemplary cross-sectional views taken along line A-A in FIG. 1.

Referring to FIGS. 2 to 5, the auxiliary intake valve device 10 according to an exemplary embodiment of the present invention may include a valve housing 20 disposed at the air cleaner cover 140, having an inlet port 22 and an outlet port 24, and having one or more inlet apertures 26 at the inlet port 22; a fixing bracket 30 within the valve housing 20; an elastic member 40 disposed on the fixing bracket 30; and one or more valves 50 supported by the elastic member 40 that selectively close the inlet apertures 26 and open the inlet apertures 26 when negative pressure is generated at the outlet port 24.

A plurality of valves 50 may be provided, the auxiliary intake valve device 10 may include a valve disc 60, the valves 50 may be disposed on the valve disc 60, and the elastic member 40 may support the valve disc 60. When negative pressure is generated at the outlet port 24, the negative pressure may be applied to the valve disc 60, causing the valve disc 60 to move toward the outlet port 24.

The bracket 30 may include a plurality of support members 32 fitted in the inlet port 22 and the support members 32 may be firmly connected to the inlet port 22. In addition, the inlet apertures 26 may have a cross-section that widens in the air flow direction and the valves 50 may have a trapezoidal cross-section that corresponds to the shape of the inlet apertures 26. Therefore, as the valves 50 open, air may easily flow into the air cleaner 110. The valves 50 may be made of an elastic material, thus allowing air-tightness to be maintained without the valves 50 opening, that is, without the filter 130 clogged, and resistance to reduce in opening the valves 50.

A filter 70 that prevents inflow of foreign substances may be disposed at the outlet port 24, thus preventing foreign substances from flowing into the combustion chamber of the engine 100.

Furthermore, the valve housing 20 may be formed in a cylinder shape and may be easily attached and detached to and from the air cleaner 110. A fixing protrusion 80 that fixes the auxiliary intake valve device 10 to the air cleaner cover 140 may be formed around the valve housing 20. Additionally, an O-ring that seals a space between the auxiliary intake valve device 10 and the air cleaner cover 140 may be fitted around the valve housing 20.

FIGS. 2 and 3 show the exemplary behavior of the auxiliary intake valve device 10 in the normal operation (e.g., when the filter is not clogged) of the air cleaner 110 and FIGS. 4 and 5 show the exemplary behavior of the auxiliary intake valve device 10 in an abnormal operation (e.g., when the filter is clogged) of the air cleaner 110 due to clogging of the filter 130.

As shown in FIGS. 2 and 3, in the normal operation of the air cleaner 110, the valves 50 may close the inlet apertures 26 due to the elastic force of the elastic member 40. In an abnormal operation of the air cleaner 110 due to foreign substances such as ice or snow flowing into the air filter 130 when a vehicle travels, negative pressure may be applied to the valve disc 60 and the valves 50 may he opened. In particular, the air may flow in via the inlet apertures 26, and may be filtered by the filter and then supplied to the engine 100. Therefore, it may be possible to prevent the engine 100 from stopping or prevent malfunction of the engine 100 while a vehicle travels.

When the air cleaner 110 is disposed on the engine, heat may be transferred to the air cleaner 110 by the operation of the engine 100 and may cause ice or snow to melt in the air filter 130, such that the air cleaner 110 may operate normally.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. An auxiliary intake valve device comprising:
a valve housing disposed at an air cleaner cover, having an inlet port and an outlet port, and having a plurality of inlet apertures at the inlet port;
a fixing bracket disposed within the valve housing;
an elastic member disposed on the fixing bracket; and
a plurality of valves supported by the elastic member and configured to selectively close the inlet apertures and open the inlet apertures when negative pressure is generated at the outlet port.

2. The valve device of claim 1, wherein the auxiliary intake valve device further includes a valve disc, the valves are disposed on the valve disc, and the elastic member elastically supports the valve disc.

3. The valve device of claim 1, wherein the bracket includes a plurality of support members fitted in the inlet port.

4. The valve device of claim 1, wherein the inlet apertures have a cross-section that widens in the air flow direction, and the valves have a trapezoidal cross-section that correspond to the shape of the inlet apertures.

5. The valve device of claim 4, wherein the valve is made of an elastic material.

6. The valve device of claim 1, wherein a filter that prevents inflow of foreign substances is disposed at the outlet port.

7. The valve device of claim 1, wherein a fixing protrusion is formed around the valve housing.

8. The valve device of claim 1, wherein an O-ring that maintains air-tightness between the auxiliary intake valve device and the air cleaner cover is fitted around the valve housing.

9. The valve device of claim 1, wherein the valve housing is formed in a cylindrical shape.

10. An intake system comprising:
an air cleaner including:
an air cleaner body with an air cleaner inlet;
an intake filter in the air cleaner body; and
an air cleaner cover combined with the air cleaner body and having an air cleaner outlet; and
an auxiliary intake valve device including:
a valve housing disposed at the air cleaner cover, having an inlet port and an outlet port, and having a plurality of inlet apertures at the inlet port;
a fixing bracket disposed within the valve housing;
an elastic member disposed on the fixing bracket; and
a plurality of valves supported by the elastic member and configured to selectively close the inlet apertures and open the inlet apertures when negative pressure is generated at the outlet port.

11. The system of claim 10, wherein the auxiliary intake valve device further includes a valve disc, the valves are disposed on the valve disc, and the elastic member elastically supports the valve disc.

12. The system of claim 10, wherein the bracket includes a plurality of support members fitted in the inlet port.

13. The system of claim 10, wherein the inlet apertures have a cross-section that widens in the air flow direction, and the valves have a trapezoidal cross-section that corresponds to the shape of the inlet apertures.

14. The system of claim 13, wherein the valve is made of an elastic material.

15. The system of claim 10, wherein a filter that prevents inflow of foreign substances is disposed at the outlet port.

16. The system of claim 10, wherein a fixing protrusion that fixes the auxiliary intake valve device to the air cleaner cover is formed around the valve housing.

17. The system of claim 10, wherein an O-ring that maintains air-tightness between the auxiliary intake valve device and the air cleaner cover is fitted around the valve housing.

18. The system of claim 10, wherein the valve housing is formed in a cylindrical shape.

19. An auxiliary intake valve device comprising:
at least one valve supported by an elastic member and configured to selectively close a plurality of inlet apertures at an inlet port of a valve housing of an air cleaner cover and open a plurality of inlet apertures when negative pressure is generated at an outlet port of the valve housing.

20. The valve device of claim 19, further comprises:
a fixing bracket disposed within the valve housing; and
an elastic member disposed on the fixing braket.
